(19) United States
(12) Patent Application Publication
(10) Pub. No.: US 2004/0009689 A1
(43) Pub. Date: Jan. 15, 2004

(54) Dustproof electrical wall socket

(76) Inventor: Chao-Chi Wang, Tainan (TW)

Correspondence Address: Rabin & Berdo, P.C., Suite 500, 1101 14th Street, Washington, DC, 20005, US

(21) Appl. No.: 10/191,496

(22) Filed: Jul. 10, 2002

(51) Int. Cl. H01R 13/44

(52) U.S. Cl. 439/139

(57) ABSTRACT

A dustproof electrical wall socket has at least one contact housing, an attachment plate, a decorative plate and a dust cover corresponding to each contact housing. The attachment plate is mounted on the wall and the at least one contact housing is connected to the attachment plate. The decorative plate is detachably connected to the attachment plate, and the dust cover is moveably mounted between the attachment plate and the decorative plate. The attachment plate also has three prong slots corresponding to each contact housing. The present invention can be conveniently assembled and installed and improves safety.

### BACKGROUND OF THE INVENTION

1. Field of the Invention

The present invention relates to an electrical wall socket, and more specifically to a dustproof electrical wall socket that is easily installed in a wall and is easy and convenient to operate.

2. Description of Related Art

Electrical wall sockets exposed to the environment are often the cause of fires in houses, factories, storage facilities and other structures. Fires start in these devices when a hot lead shorts inside the device.

The accumulation of airborne dust and grime between conductive elements or conductive elements and ground in a wall socket when the wall socket is not in use forms a conductive path with a hot element in the socket, which shorts the socket. Therefore a conventional wall socket that has not been otherwise protected from airborne contaminants is not safe.

The present invention provides a dustproof electrical wall socket that can protect the hot elements of a socket from dust and contaminants in the air to mitigate or obviate the aforementioned problems.

### SUMMARY OF THE INVENTION

An objective of the present invention is to provide a dustproof electrical wall socket with a dust cover, which can be easily installed in or on a wall and protect the internal components of the electrical wall socket from dust and contaminants in the air. Therefore, the wall socket is more convenient and safer to use.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a dustproof electrical wall socket in accordance with the present invention;

FIGS. 2A and B are operational front plan views of the dustproof electrical wall socket in FIG. 1;

FIG. 3 is an exploded perspective view of a second embodiment of a dustproof electrical wall socket in accordance with the present invention; and

FIGS. 4A and B are operational front plan views of the dustproof electrical wall socket in FIG. 3.

### DETAILED DESCRIPTION OF THE PREFERRED EMBODIMENT

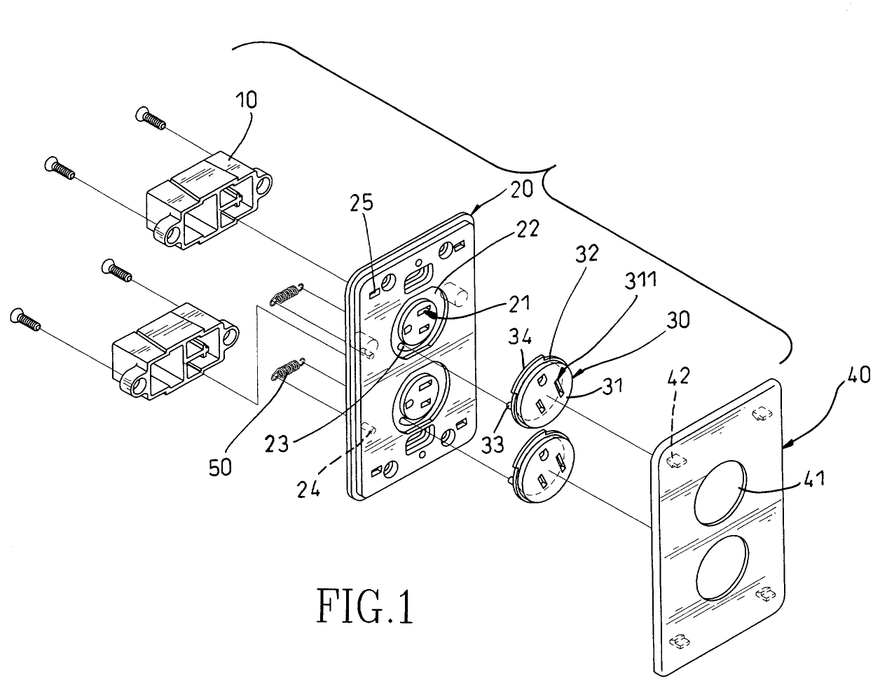

With reference to FIG. 1, a first embodiment of a dustproof electrical wall socket comprises at least one contact housing (10), an attachment plate (20), a dust cover (30), and a spring (50) corresponding to each contact housing (10) and a decorative plate (40).

Three electrical contacts (not shown) are mounted in each contact housing (10). The attachment plate (20) has a front face, a back face and at least two attachment slots (25), and the attachment plate (20) is used to attach the dustproof electrical wall socket to a wall. A rod (24) corresponding to each contact housing (10) is formed integrally with and extending from the back face of the attachment plate (20). A set of prong slots (21) corresponding to each contact housing (10) is integrally defined through the front face of the attachment plate (20) and each prong slot (21) corresponds to an electrical contact (not shown). A circular recess (22) with a flat top and bottom section is defined in the front face of the attachment plate (20) around each set of prong slots (21), which results in a raised circular front face through which the prong slots (21) pass. An arced slot (23) is defined in the recess (22) concentric with the raised circular front face. When the contact housings (10) are attached to the attachment plate (20), the prong slots (21) align with the contacts in the contact housings (10), and the attachment plate (20) is attached to the wall.

The dust cover (30) has a front and a back and is circular with an outer edge, a raised, circular front face (31), a lip (32) and two wings (34). The lip (32) is formed around the outer edge of the dust cover (30), and the two wings (34) extend from opposite sides of the lip (32). Three prong holes (311) corresponding to the prong slots (21) are defined through the raised circular front face (31) of the dust cover (30). A shaft (33) is integrally formed with the lip (32) and extends from back of the dust cover (30). The shaft (33) corresponds to the arced slot (23) in the attachment plate (20). When the dust cover (30) is mounted on the attachment plate (20), the shaft (33) extends through the arced slot (311), and the wings (34) are mounted in circular part of the recess (22) of the attachment plate (20). The dust cover (30) selectively covers one set of prong slots (311). The raised circular front face (31) and the shaft (33) of the dust cover (30) protrude from the front face and the back face of the attachment plate (20), respectively.

The decorative plate (40) has a front, a back and a circular opening (41) corresponding to each contact housing (10). At least two resilient hooks (42) are formed on the back of the decorative plate (40) to detachably connect to the attachment slots (25) in the attachment plate (20). When the decorative plate (40) is attached to the attachment plate (20), the opening (41) in the decorative plate (40) fits around the raised circular front face (31) of the dust cover (30) and holds the lip (32) against the back of the decorative plate (40). Thus the dust cover (30) can rotate between the attachment plate (20) and the decorative plate (40).

The spring (50) has two ends with one end connected to the shaft (33) on the back of the dust cover (30) and the other end connected to the rod (24) on the back face of the attachment plate (20). The arced slot (23) in the attachment plate (20) simply allows the shaft (33) to protrude through the attachment plate (20). The rotation of the dust cover (30) is limited by the wings (34) abutting the flat top and bottom sections of the recess (22).

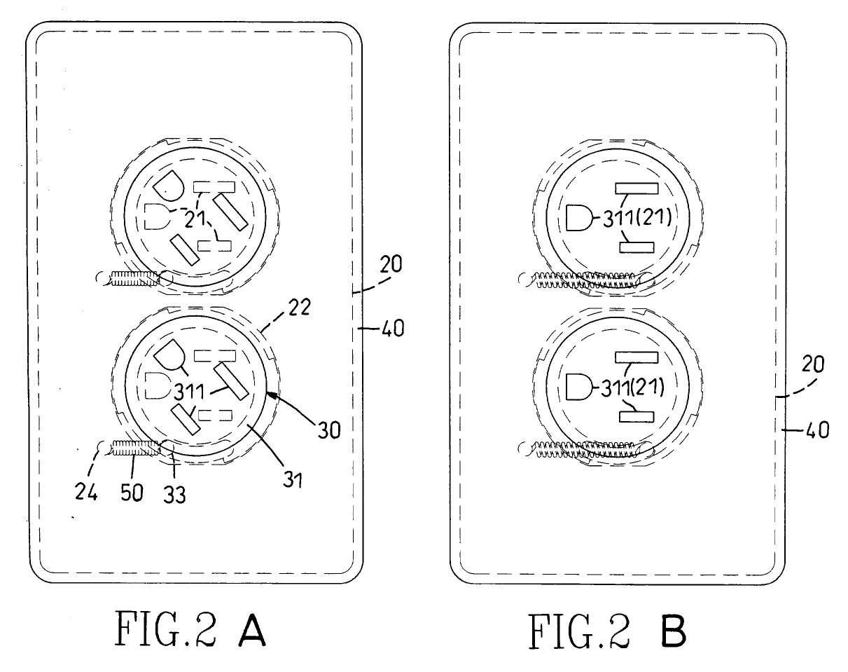

With reference to FIG. 2, the spring (50) pulls the shaft (33) on the dust cover (30) toward the rod (24) on the attachment plate (20). When the electrical wall socket is not in use, the dust cover (30) completely covers the three prong slots (21) in the attachment plate (20). With reference to FIG. 2B, the dust cover (30) is rotated until the prong holes (311) align with the corresponding prong slots (21) so the prongs on a plug (not shown) can be inserted into the contact housing (not shown). With reference to FIG. 2A, the spring (50) automatically rotates the dust cover (30) to its original position when the plug is removed so the dust cover (30) closes the prong slots (21) in the attachment plate (20).

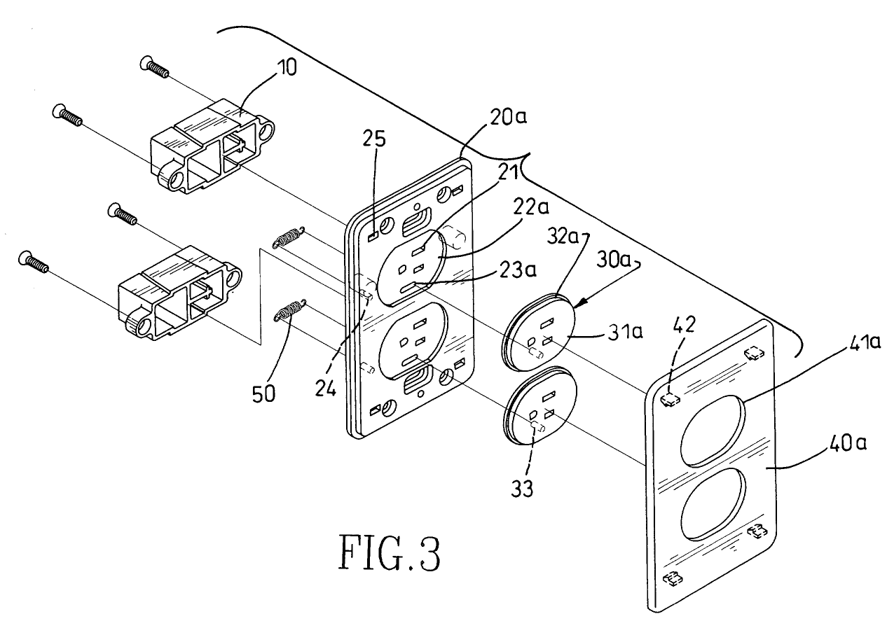

With reference to FIG. 3, another embodiment of an electrical wall socket in accordance with the present invention comprises at least one contact housing (10), an attachment plate (20a), a dust cover (30a) and a spring (50) corresponding to each contact housing (10) and a decorative plate (40a). The structure of this embodiment is fundamentally the same as the embodiment previously described except that the dust cover (30a) moves linearly rather than rotates. The functions and capabilities of the two embodiments are the same. Consequently, only the differences in this embodiment will be described.

The attachment plate (20a) has a couple of minor structural differences that allow the dust cover (30a) to move linearly rather than rotate. A rectangular recess (22a) with rounded ends is defined in the front of the attachment plate (20a) to correspond to each contact housing attached to the back of the attachment plate (20a). A set of three prong slots (21) and a straight slot (23a) are defined through the bottom of each recess (22a). The dust cover (32a) is shaped to be moveably mounted in the access (22a). A raised oblong front face (31a) is formed on the dust cover (30a) that results in a lip (32a) being formed around the dust cover (30a). An oblong opening (41a) is defined through the decorative plate (40a) to correspond to each recess (22a) to slidably hold the raised oblong front face (3 1a) of the dust cover (30a). When the decorative plate (40a) is attached to the attachment plate (20a), the opening (41a) holds the corresponded raised oblong front face (31 a) of the dust cover (30a). The dust cover (30a) can move linearly in the recess (22a) and the opening (41 a).

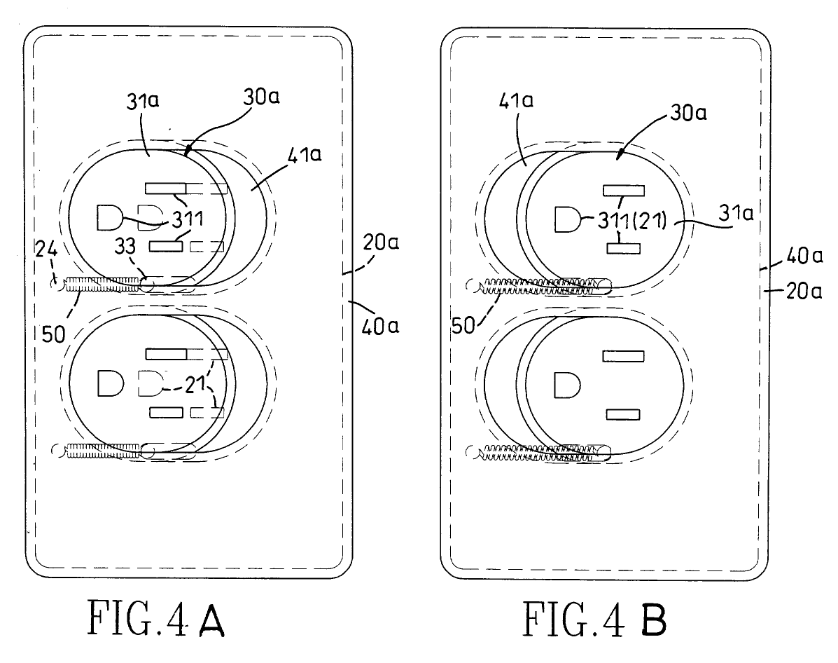

With reference to FIGS. 4A, the dust cover (30a) also completely covers all the prong slots (21) to prevent dust in the air from entering the dustproof wall socket when the socket is not being used. The spring (50) pulls the shaft (33) on the dust cover (30a) toward the rod (24) on the attachment plate (20a). With reference to FIG. 4B, the dust cover (30) moves laterally to align the prong holes (311) in the dust cover with the prong slots (21) in the attachment plate (20a) so that the plug (not shown) can be inserted into the contact housing (not shown).

As described, the electrical wall socket in accordance with the present invention can effectively protect the inside of the wall socket from dust and other solid contaminants in the air. Furthermore, the wall socket has fewer components than the conventional socket, that is the prong slots are integrated on the attachment plate. Therefore the present invention easily mounts in the wall and has a dustproof capability.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A dustproof electrical wall socket, comprising
at least one contact housing;
an attachment plate with a front and a back adapted to be mounted on a wall and to which the contact housings are attached, wherein the attachment plate has a set of prong slots corresponding to each contact housing;
a dust cover corresponding to each set of prong slots has a front and a back and moveable mounted on the attachment plate to cover the corresponding set of the prong slots, wherein each dust cover has three prong holes defined through the dust cover to correspond to the prong slots; and
a decorative plate detachably attached to the attachment plate, wherein an opening corresponding to each dust cover is defined through the decorative plate.

2. The dustproof electrical wall socket as claimed in claim 1, wherein a circular recess with a flat top and bottom section is defined around each set of prong slots on the attachment plate and each dust cover has a front and a back and is circular with an outer edge, a raised circular front face, a lip and two wings, wherein the wings of the each dust cover are rotatably mounted in the corresponding one of the circular recesses and abut the flat top and bottom sections to limit the rotation of the dust cover, and the three prong holes are defined in the raised circular front face.

3. The dustproof electrical wall socket as claimed in claim 2, wherein an arced slot is formed in each circular recess in the attachment plate and is concentric with the raised face, and a shaft is formed on and extends from the back of the each dust cover under the lip to pass through the arced slot.

4. The dustproof electrical wall socket as claimed in claim 3, wherein at least one rod is formed on the back of the attachment plate, and a spring with two ends is connected between the rod and the shaft that protrudes through the arced slot in the attachment plate to provide a biasing force on the dust cover.

5. The dustproof electrical wall socket as claimed in claim 1, wherein at least one approximately rectangular shaped recess is defined in the attachment plate and each at least one approximately rectangular shaped recess communicates with each set of the prong slots, and each dust cover is approximately rectangular shaped and comprised of a raised oblong front face and a lip, wherein the lip of the dust cover is mounted in the recess to move in a straight-line, and the three holes are defined in the raised circular front face.

6. The dustproof electrical wall socket as claimed in claim 5, wherein a straight slot is formed in each recess in the attachment plate and a shaft extends from the lip of each dust cover and passes through the straight slot.

7. The dustproof electrical wall socket as claimed in claim 6, wherein at least one rod extend from the back of the attachment plate, a spring is connected between each at least one rod and the shaft of each dust cover to provide a biasing force on the dust cover.

8. The dustproof electrical wall socket as claimed in claim 1, wherein further comprises an attaching means comprised of at least two mounting slots in the attachment plate and at least two resilient hooks on the decorative plate to detachably connect to the corresponded mounting slots.
